(19) United States
(12) Patent Application Publication
(10) Pub. No.: US 2012/0174205 A1
(43) Pub. Date: Jul. 5, 2012

(54) USER PROFILE AND USAGE PATTERN BASED USER IDENTIFICATION PREDICTION

(75) Inventors: Jason C. EDMEADES, Chandlers Ford (GB); Peter J. JOHNSON, Chandlers Ford (GB); David LOCKE, Chandlers Ford (GB); Clare J. OWENS, Chandlers Ford (GB); Fenglian XU, Chandlers Ford (GB)

(73) Assignee: International Business Machines Corporation, Armonk, NY (US)

(21) Appl. No.: 12/983,017

(22) Filed: Dec. 31, 2010

(51) Int. Cl. G06F 7/04

(52) U.S. Cl. 726/7; 726/18

(57) ABSTRACT

Embodiments of the present invention provide method, system and computer program product for user profile and usage pattern based user ID prediction. In accordance with an embodiment of the invention, a user can request a user ID to access a portion of a computing system. One or more characteristics of the user, such as a role or location can be determined and correlated to one or more different additional user ID options. In this regard, the additional user ID options can be a suggested alternative user ID for use by the user commensurate with the role or location of the user, or with past patterns of other users considered similar to the user based upon the characteristics of the user. In this way, the predictive nature of the foregoing methodology can assist the user in requesting a most appropriate user ID based upon the characteristics of the user and also in requesting a user ID which may be required in the future by the user based upon predictive patterns of system usage of other like users so as to save time and improve work efficiency.

### BACKGROUND OF THE INVENTION

1. Field of the Invention

The present invention relates to the field of access control to computing resources and more particularly to control of access to computing systems and resources using user identifications.

2. Description of the Related Art

The development and widespread use of the computer in the past half century has given rise to dramatically greater efficiencies in the way individuals and organizations manage their respective daily activities. The shear organizational power of the combination of a computer with disk storage has opened new opportunities to advance the efficiency in performing a given task. For smaller computer systems, accessing the resources and computational power of the computing system can require little more than applying power to the computing system and directing execution of the pertinent applications. For more complicated systems—particularly systems deployed within a computer communications network, managing access to the resources of the computing system can be much more of a chore.

In this regard, access control involves managing who has access to specific systems and resources at a given time. Generally, access control includes three basic steps: identification, authentication, and authorization. Identification normally requires a user to enter a user identification (ID) at the time of logging in. The purpose of authentication is to verify the user's identity. Passwords, voice recognition, and biometric scanners are common methods of authentication. After a user has been authenticated, the user is then authorized to use the system. The user is generally only authorized to use a portion of the resources of a system depending upon the role in of the user within the organization. For example, the engineering staff of an organization would enjoy access to different applications and files than the finance or human resource staff of the organization.

Often times users, especially knowledge workers, may require access to different systems or resources than the norm in order to complete a required task. It is often the case that various user IDs will be required in order to access the systems or resources needed yet lacked by the user. Yet, the process of registering for such required IDs by the user can take a great deal of time, especially when approvals such as management sign-offs are required. It can be particularly frustrating if a user only discovers that a particular ID is required at the time at which the ID is needed, not in advance.

### BRIEF SUMMARY OF THE INVENTION

Embodiments of the present invention address deficiencies of the art in respect to access control and ID management and provide a novel and non-obvious method, system and computer program product for user profile and usage pattern based user ID prediction. In an embodiment of the invention, a method for predictive user ID request processing is provided. The method includes receiving a request for a user ID from a user to access a portion of a computing system. Thereafter, at least one characteristic of the user, such as role or location can be determined and the characteristic can be correlated to at least one user ID option that differs from the requested user ID. In this regard, the correlation can be based upon the determined characteristic of the user, and a mapping of user ID patterns by other users of the computing system and the characteristics of the other users.

Finally, once a user ID option has been correlated to the user, the user can be prompted to accept the user ID option. In this regard, to the extent that user ID option is a proposed alternative user ID to be used to access the portion of the system, the user can be prompted to accept the alternative user ID in lieu of the requested user ID. Likewise, to the extent the user ID option is an additional user ID to be used to access a different portion of the computing system, the user can be prompted to accept both the requested user ID and the additional user ID to access both portions of the computing system.

In another embodiment of the invention, a user ID management data processing system can be provided. The system can include a computer with at least one processor and memory and fixed storage configured for coupling to multiple different resources of a computing system. The system also can include an operating system executing in the computer. The system yet further can include a user ID predictor module coupled to the operating system and executing in the memory of the computer. Specifically, the module can include program code enabled to receive a request for a user ID from a user to access a portion of the computing system, to determine at least one characteristic of the user such as a role or location, to correlate the characteristic of the user to at least one user ID option that differs from the requested user ID, and to prompt the user to accept the user ID option.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for predictive user ID request processing;

FIG. 2 is a schematic illustration of a data processing system configured for predictive user ID request processing; and

FIG. 3 is a flow chart illustrating a process for predictive user ID request processing.

### DETAILED DESCRIPTION OF THE INVENTION

Embodiments of the invention provide for predictive user ID request processing. In accordance with an embodiment of the invention, a user can request a user ID to access a portion of a computing system. One or more characteristics of the user, such as a role or location can be determined and correlated to one or more different additional user ID options. In this regard, the additional user ID options can be a suggested alternative user ID for use by the user commensurate with the role or location of the user, or with past patterns of other users considered similar to the user based upon the charactersitics of the user. In this way, the predictive nature of the foregoing methodology can assist the user in requesting a most appropriate user ID based upon the characteristics of the user and also in requesting a user ID which may be required in the future by the user based upon predictive patterns of system usage of other like users so as to save time and improve work efficiency.

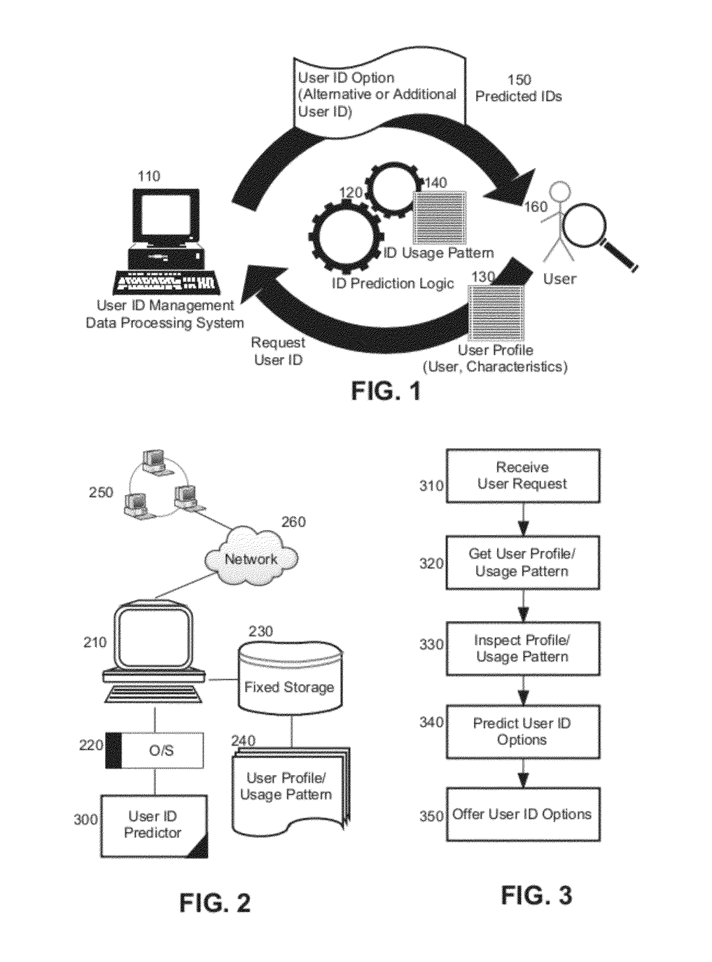

In more particular illustration, FIG. 1 pictorially shows a process for predictive user ID request processing. As shown in FIG. 1, a user 160 can request an ID from a user ID management data processing system 110. Upon receiving the user ID request, the ID prediction logic 120 of the user ID management data processing system 110 can inspect the user profile 130 associated with the user and the ID usage pattern profile 140 and predict one or more user ID options 150 that are appropriate for the user or that the user may need in the future. Subsequently, the user ID management data processing system 110 offers the predicted one or more user ID options 150 to the user 160.

Of note, the user profile 130 can contain information such as the job role and location of the user. The ID prediction logic 120 can inspect the user profile information of the profile 130 in order to offer different user ID options to different users based upon their respective job roles. For example, an administrator requesting a normal ID for one system resource may be offered the option to request an administrator ID for the system resource while a non-administrator would not be offered this option.

The ID usage pattern profile 140 can be created within the user ID management data processing system 110. First, ID usage data can be gathered by the ID management data processing system 110 from access by all users to different systems and resources for a period of time. The gathered ID usage data can then be analyzed to identify patterns of usage of different systems and resources by different users of particular charactersitics such as job role or location. The resultant patterns can be included in the ID usage pattern profile 140. Based on the ID usage pattern profile information, the ID prediction logic 120 can form certain rules for making user ID predictions. For example, if the ID usage data indicates that a percentage of users who request an ID with one system subsequently request a user ID with another system, the ID prediction logic 120 may offer a user who requests an ID with the first system the option to also request a user ID with the second system.

The process described in connection with FIG. 1 can be implemented in a user ID management data processing system. In further illustration, FIG. 2 schematically depicts a user ID management data processing system configured for predictive user ID request processing. The system can include a host computer 210 with at least one processor and memory coupled to fixed storage 230 and supporting the execution of an operating system 220. The host computer 210 can be connected to a plurality of other computing systems and resources 250 via wired or wireless network connections 260. Users can request access to the computing systems and resources 250 through the user ID management data processing system.

Of note, a user ID predictor module 300 can be coupled to the operating system 220. The module 300 can include program code that when executed by one or more of the processors of the host computer 210, can respond to a user request of an ID to inspect the user profile and the user ID usage pattern 240 stored in the fixed storage 230 and predict one or more ID options that are appropriate for the user or that the user may need in the future. Specifically, the program code of the module 300 can be enabled upon execution in the host computer 210 to determine one or more charactersitics of the user requesting a user ID to access one of the computing systems and resources 250. The charactersitics can be used by the program code of the module 300 in reference to the user profile and the user ID usage pattern 240 stored in the fixed storage 230 to map to one or more user ID options appropriate for the user.

In yet further illustration of the operation of the user ID predictor module 300, FIG. 3 is a flow chart illustrating a process for predictive user ID request processing. Beginning in block 310, a user request for an ID can be received. In block 320, the user profile and the ID usage pattern profile can be retrieved from the storage. In block 330, the information contained in the user profile and the ID usage pattern profile can be inspected. In block 340, one or more user ID options can be predicted based on the result of the inspection and predefined rules. Finally, in block 350, the predicted one or more ID options can be offered to the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1.-7. (canceled)

8. A user ID management data processing system comprising:
a computer with at least one processor and memory and fixed storage and configured for coupling to a plurality of computing resources in a computing system;
an operating system executing in the computer; and
a user ID predictor module coupled to the operating system and executing in the computer, the module comprising program code enabled to receive a request for a user ID from a user to access a portion of the computing system, to determine at least one characteristic of the user, to correlate the characteristic of the user to at least one user ID option that differs from the requested user ID, and to prompt the user to accept the user ID option.

9. The system of claim 8, wherein the characteristic is a job role for the user.

10. The system of claim 8, wherein the characteristic is a location of the user.

11. The system of claim 8, wherein the user ID option is an alternative user ID to be used in place of the requested user ID.

12. The system of claim 8, wherein the user ID option is a user ID for use with a different portion of the computing system.

13. A computer program product for predictive user ID request processing, the computer program product comprising a computer readable storage medium having computer readable program code embodied therewith, the computer readable program code comprising:
computer readable program code for receiving a request for a user ID from a user to access a portion of a computing system;
computer readable program code for determining at least one characteristic of the user;
computer readable program code for correlating the characteristic of the user to at least one user ID option that differs from the requested user ID; and,
computer readable program code for prompting the user to accept the user ID option.

14. The computer program product of claim 13, wherein the computer readable program code for determining at least one characteristic of the user, comprises:
computer readable program code for retrieving a user profile associated with the user, the user profile specifying a plurality of characteristics of the user.

15. The computer program product of claim 14, wherein the computer readable program code for correlating the characteristic of the user to at least one user ID option that differs from the requested user ID, comprises:
additionally retrieving an ID usage pattern profile created based on ID usage data gathered from all users; and,
selecting a user ID option from the ID usage pattern profile corresponding to the retrieved user profile.

16. The computer program product of claim 13, wherein the characteristic is a job role for the user.

17. The computer program product of claim 13, wherein the characteristic is a location of the user.

18. The computer program product of claim 13, wherein the user ID option is an alternative user ID to be used in place of the requested user ID.

19. The computer program product of claim 13, wherein the user ID option is a user ID for use with a different portion of the computing system.
